(19) United States
(12) Patent Application Publication
(10) Pub. No.: US 2008/0036618 A1
(43) Pub. Date: Feb. 14, 2008

(54) Component for Alarm System

(76) Inventor: Lee Von Gunten, West Jordan, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/463,647

(22) Filed: Aug. 10, 2006

(51) Int. Cl. G09F 9/33; G08B 21/00; G08B 23/00

(52) U.S. Cl. 340/815.45; 340/540; 340/693.5

(57) ABSTRACT

The present invention is a component for an alarm system that may serve as an active component or an inactive, or decoy, component. The component is a small casing mountable in a visible manner that indicates activation with a flashing LED. Inside the component, the circuitry necessary to flash the LED and possibly monitoring devices, depending on the component's status as an active or inactive component. Active components also have security monitoring devices contained within the casing that monitor the surrounding environment through an access port. When a situation in the environment is registered by the device, it sends a signal to the alarm system of which it is a part. As added utility, the active and inactive components are outwardly indistinguishable, thus allowing the inactive components to serve as decoys either within a subscriber's alarm system or with non-subscriber's property, thus fulfilling a need for a high-tech version of the posted sign deterrent used in the alarm system industry today.

### FIELD OF THE INVENTION

The present invention relates to the field of alarm systems and more particularly relates to a visible component for an alarm system that serves as a deterrent as well as an integral part of an alarm system.

### BACKGROUND OF THE INVENTION

Alarm companies regularly engage in two practices in the promotion of their business. The first, and most obvious, is the installation of security systems in residences and commercial buildings. These security systems have, over the years gotten very sophisticated and utilize a number of different sensors, such as heat, motion, sound, smoke and other types of security sensors, to monitor a building. The second practice is to give out signs, stickers and other indicia to both customers and non-customers to indicate that a building or other area is secured by that company. Of course, the purpose of the indicia for customers is obvious, deterrence and advertising, but companies give out the indicia to non-customers as both good-will and to expand their perceived areas of protection. The “decoy” indicia provide a measured security to non-customers as a deterrent. However, signs and stickers are often left to the elements and potential intruders know that there is a significant percentage of such signs that are, in fact, lying. What is needed, then, is a component for an alarm system that lends itself to easy replication in both active and inactive, or “decoy” forms, to increase the credibility of the decoy components.

The present invention is a component for an alarm system that can serve either as an integral part of an alarm system or a decoy, depending upon contained security devices. The present invention represents a departure from the prior art in that the component may actually be a part of an alarm system, rather than a simple sign that may be abused or even lost over time. The component lends itself to easy non-customer-maintenance in the event it is used as a decoy and may be mass produced for cost effective use as both component and decoy.

### SUMMARY OF THE INVENTION

In view of the foregoing disadvantages inherent in the known types of alarm components and decoy measures, this invention provides a visible component that may be used as both an active component and as a decoy, depending on the component's contents. As such, the present invention's general purpose is to provide a new and improved component that is visible and attracts attention while capable of containing security devices for use in an alarm system.

To accomplish these objectives, the system component comprises a casing visibly mountable on a surface and circuitry within said casing for the component's purpose. The component also features a visible activation indicator, such as a flashing LED, to draw attention to the component. The purpose of the component may be as a sensor for motion, smoke, carbon monoxide or heat, may be as a miniature camera, or it may serve merely as a decoy and have no purpose other than deterrence. The key in providing utility to the inactive, or decoy, components, is that the inactive and active components are visually indistinguishable from each other, so that a would be intruder knows the component is present but not if it is real or a decoy. Ideally, the component is to be mounted upon the inside of a window, either of a building or a vehicle, and, as such, the obverse would be obscured from inside view. The present invention also features a viewing port, so that when the LED flashes, it is visible both on the obverse and through the reverse of the component and indicates activation.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front side plan view of the component.

FIG. 2 is a right elevation view of the component.

FIG. 3 is a back side plan view of the component.

FIG. 4 is a top elevation of the component.

FIG. 5 is a circuit diagram of the blinking LED circuitry utilized in the an inactive component according to the present invention.

FIG. 6 is a schematic of an active component according to the present invention.

### DETAILED DESCRIPTION OF THE PREFERRED EMBODIMENT

With reference now to the drawings, the preferred embodiment of the alarm system component is herein described. It should be noted that the articles “a”, “an” and “the”, as used in this specification, include plural referents unless the content clearly dictates otherwise.

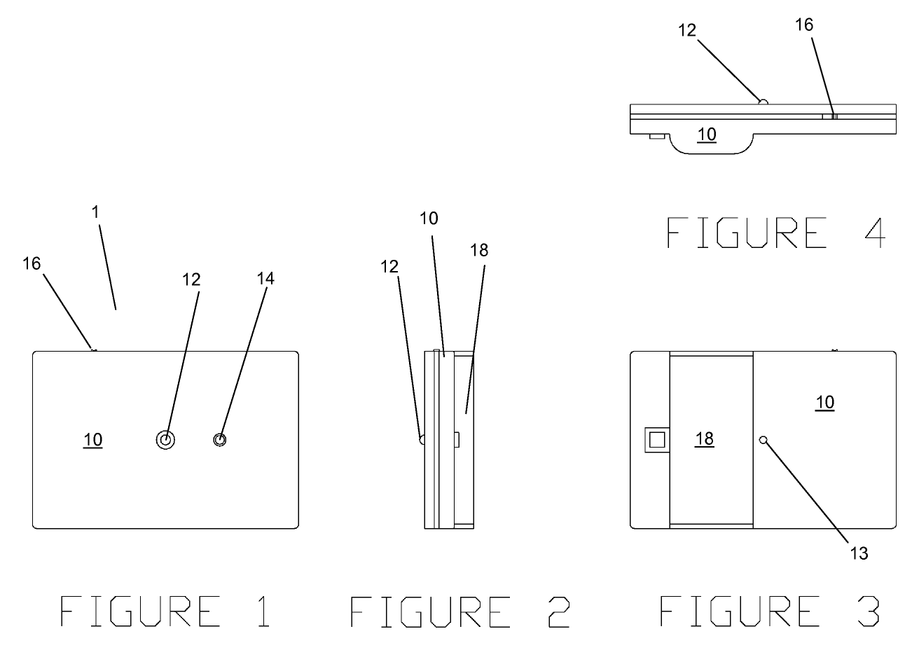

With reference to FIGS. 1-4, the component 1, whether active or inactive, is housed in casing 10 that supports a visible LED 12, a utility port 14 and switch 16. The reverse of the casing 10, has battery cover 18 and an operation verification port 13, so that LED 12 is viewable from both outside and inside a secured location when mounted with the obverse against a window. Without the operation verification port 13, LED 12 would not be viewable from the inside, forcing a user to verify operation be going outside and viewing the LED 12.

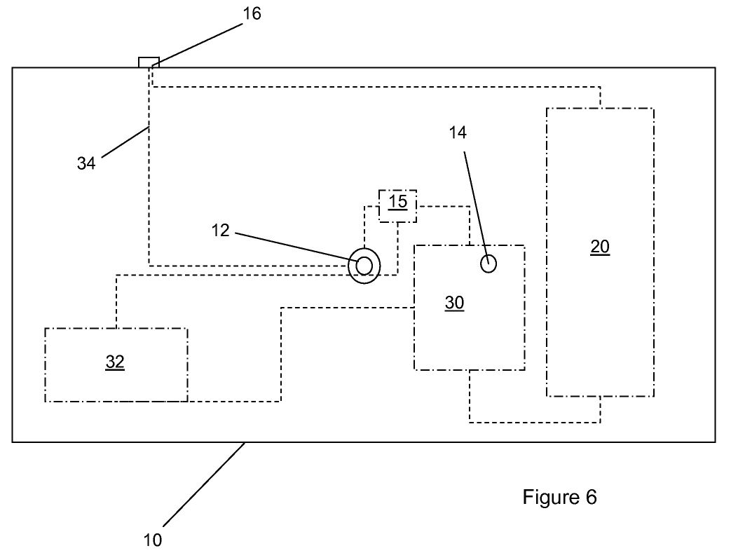

One of the keys to the utility of this invention is that inactive and active components are outwardly indistinguishable. An active component, shown in schematic in FIG. 6 would have the battery 20 operably connected by circuitry 34 to the switch and a security device 30 which would monitor the environment through the utility port 14. When in scanning mode, the circuit 34 continues through an integrated circuit 15 and the LED 12. The device may be any number of security micro-devices or sensors on the market or later developed, including but not limited to: smoke, carbon monoxide, light, noise, proximity or motion detectors, heat sensors, miniature cameras, microphones or any other security device that can be made to fit within the volume of the component 1. In its preferred embodiment, the component 1 is small enough to be unobtrusive and light, but large enough to contain necessary components. In its present preferred embodiment, the component has a rectangular obverse measuring about 3.625″ by 2.125″ and has a variable depth ranging from 0.325″ to 0.625″. However, these dimensions should not be seen as limiting, as preferred use will dictate eventual size. When the device 30 registers a pertinent change in it the environment is monitoring, it activates a signaling sub-system 32 to send data to the resident security system. This sub-system may be connected to the alarm system by being hardwired into the system or by an RF or wireless connection. An inactive component would look identical to the active component, thus would sport wires is the active components were hardwired, but would only contain the LED 12 and IC 15.

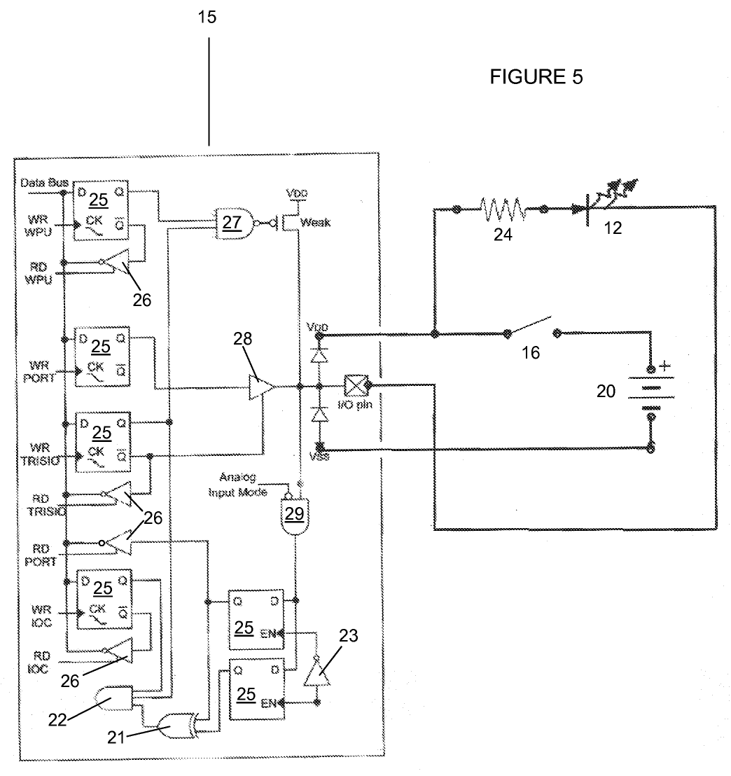

FIG. 5 depicts a simple circuit diagram for a blinking LED that may be used in either active or inactive components according to the present invention. The disclosed IC minimizes power consumption and extends battery life by switching the LED on and off without an oscillator, though any suitable IC may be used. In the alternative, a traditional oscillator may be used at the sacrifice of battery life. As shown, LED 12 is connected to a resistor 24 the switch 16, the integrated circuit 15 and the power supply 20. In the enlarged portion of the figure depicting the integrated circuit 15, which should be understood by those with knowledge in this art once the appropriate components are disclosed. The components are labeled as follows: 25 indicates one of six type D flip-flops, 26 indicates one of four gated inverters, 27 is a NAND Gate, 28 is a Non-inverting buffer, 29 is a 2-input AND gate, 30 is an inverter, 31 is an XOR gate, and 32 is a 3-input AND gate.

In use, the active components are utilized as an active component in an alarm system. Inactive components may be used as decoys or my be given or sold to non-subscribing individuals, following the current practice in the alarm system industry of giving signs to non-subscribers to serve as both advertising and a deterrent as thieves do not know if the sign is a bluff or if the property really is under surveillance.

While depicted as being battery powered, the component may be configured for an external power supply, such as from being hardwired into an alarm system. Again, the only requirement for the decoy to retain utility is that the decoys be indistinguishable from the active components, so they, too, should have some indication of external power, such as wires “connecting” them to the system extending out of the sightline of potential intruders.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A security device for a premises comprising:
a. A housing having an obverse and a reverse, said obverse having a utility port;
b. A power supply;
c. An LED mounted such that it is viewable on the obverse of the housing; and
d. An integrated circuit operatively connected to the power supply and the LED;
Wherein the integrated circuit controls electrical current from the power supply to the LED such that the LED blinks.

2. The device of claim 1, further comprising:
a. A security monitoring device mounted within the housing such that the monitoring device may monitor the surrounding environment through the utility port; and
b. Means of operable connection between the device and a security system.

3. The device of claim 2, the security monitoring device being selected from the set of security monitoring devices consisting of: heat sensors, motion sensors, light sensors, noise sensors, microphones, cameras, smoke detectors, carbon monoxide detectors, and proximity detectors.

4. The device of claim 2, the means of operable connection being a wireless communicative connection between the device and the system.

5. The device of claim 4, the security monitoring device being selected from the set of security monitoring devices consisting of: heat sensors, motion sensors, light sensors, noise sensors, microphones, cameras, smoke detectors, carbon monoxide detectors, and proximity detectors.

6. The device of claim 1 further comprising a verification port located on the reverse of the device such that the LED is viewable from the reverse of the device.

7. The device of claim 6, further comprising:
a. A security monitoring device mounted within the housing such that the monitoring device may monitor the surrounding environment through the utility port; and
b. Means of operable connection between the device and a security system.

8. The device of claim 7, the security monitoring device being selected from the set of security monitoring devices consisting of: heat sensors, motion sensors, light sensors, noise sensors, microphones, cameras, smoke detectors, carbon monoxide detectors, and proximity detectors.

9. The device of claim 7, the means of operable connection being a wireless communicative connection between the device and the system.

10. The device of claim 9, the security monitoring device being selected from the set of security monitoring devices consisting of: heat sensors, motion sensors, light sensors, noise sensors, microphones, cameras, smoke detectors, carbon monoxide detectors, and proximity detectors.
